(19) United States
(12) Patent Application Publication
(10) Pub. No.: US 2013/0096939 A1
(43) Pub. Date: Apr. 18, 2013

(54) Methods and Systems for Patient Self-Management

(71) Applicant: Sarah L. Russell, Philadelphia, PA (US)

(72) Inventor: Sarah L. Russell, Philadelphia, PA (US)

(21) Appl. No.: 13/650,473

(22) Filed: Oct. 12, 2012

Related U.S. Application Data
(60) Provisional application No. 61/547,304, filed on Oct. 14, 2011.

(51) Int. Cl. G06Q 50/22

(52) U.S. Cl. 705/2

(57) ABSTRACT

A method for managing patient care, the method comprising receiving via input device and storing in electronic format a prescription for a dosage of at least one medication, wherein the dosage varies based upon at least one patient parameter; automatically electronically transmitting a first message at an identified time to an electronic device associated with the patient, the first message prompting the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating several of the steps at identified intervals.

### BACKGROUND

The concept of “remote” healthcare delivery, or “telemedicine,” has its origins in the movement to improve access to healthcare. For many years, telemedicine was defined as healthcare delivered over a phone line to rural areas and those communities without specialists. In recent years, however, telemedicine has taken on new meaning Today, we consider as telemedicine any process that delivers care remotely, which now includes healthcare via the internet and healthcare delivered via mobile device.

A number of forces are driving disease management outside of the physician's office and into the daily lives of patients: the rising cost of outpatient visits, the decreasing availability of primary care physicians, and the increasing evidence that patient self-management leads to better primary care outcomes all push the trend toward “patient-driven” healthcare. However, in the case of patients with chronic medical conditions, such as diabetes, recurrent hospitalizations are the norm. These hospitalizations are usually considered preventable with high-quality health care and patient adherence to treatment.

There are some chronic illnesses for which changes in disease parameters trigger a change in treatment. Diabetes is an example of a disease in which disease parameters trigger a change in treatment. Due to the body's inability to use insulin effectively to manage sugar, the patient must test the level of sugar in the blood and then administer an amount of insulin that is tailored to that level of blood sugar. Such a regular and routine adjustment of one's medicines is perhaps the most critical aspect of self-management of chronic disease. And yet, this is the part of disease management with which patients most often struggle. However, because of the rapid changes in blood sugar, patient self-management is the only feasible way to effectively treat the disease.

For other diseases, however, patient-self management has not been the standard of care. Despite the fact that for some diseases such as hypertension and congestive heart failure, home monitoring is relatively easy and available and the medications used to treat the same have a wide margin of safety, most patients regularly visit their health care provider for medication dosage changes (DeMonaco and von Hippel, PLoS Medicine, 4(4):606-11 (April 2007)).

Successful out-of-the-office home care requires more than just the patient's purchase and download of a mobile health application. Those applications may be helpful but they lack the critical element of the patient-doctor relationship. Instead of leaving chronic disease management to the patient, a partnership between doctor and patient is necessary.

### SUMMARY

The present invention provides a Patient Self-Management System (PSM) which decreases mortality associated with chronic disease, costs associated with outpatient visits and re-hospitalization, and empowers patients to manage their own illness. Mobile phone-based clinical algorithms, or “toolkits”, are provided, that enable patient interaction and promote patient health through text messages and share that content with electronic medical records. Rather than have patients initiate the management of their own disease, the present invention brings them back in touch with their physician, who guides and establishes the plan of care. And rather than ask physicians to maintain constant contact with patients, with frequent office visits and live communication, the present invention allows patients to control their own daily management.

The PSM system allows physicians to maintain autonomy and control over their patients' daily medications adjustments through the use of customizable algorithms. Once an algorithm has been prescribed, the patient then receives regular messages asking them for specific values of disease parameters. Those results trigger specific responses from a central server and all data from the interaction is stored. Should patients enter values that the algorithm has determined to be problematic, a message is sent to the physician (via page, email or text message, for example), who can then reach the patient.

In one aspect, a method for managing patient care is provided. The method comprises the steps of receiving via input device and storing in electronic format a prescription for a dosage of at least one medication, wherein the dosage varies based upon at least one patient parameter; automatically electronically transmitting a first message at an identified time to an electronic device associated with the patient, the first message prompting the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating one or more of the steps at identified intervals.

In another aspect, a method for managing patient care is provided. The method comprises the steps of receiving from a health care provider, via input device and storing in electronic format, a selection of a specific patient treatment algorithm from a list of pre-determined treatment algorithms, the selection corresponding to a patient's health care status; automatically generating a series of prompts based on the selected algorithm, the prompts requesting patient-specific data; receiving from the health care provider, via input device and storing in electronic format, patient-specific data in response to prompts, the data providing a patient-customized algorithm; and automatically generating and transmitting an electronic message to an electronic device associated with the patient, the electronic message being generated based on the patient customized algorithm.

In another aspect, a computer-usable medium comprising a computer program code is provided. The computer program code is configured to cause a processor to execute one or more functions comprising receiving via input device and storing in electronic format a prescription for a dosage of at least one medication, wherein the dosage varies based upon at least one patient parameter; automatically electronically transmitting a first message at an identified time to an electronic device associated with the patient, wherein the first message prompts the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating one or more of the steps at identified intervals.

In another aspect, a method for managing patient care is provided. The method comprises developing and electronically recording and storing a plan of treatment for a patient. The plan of treatment comprises a prescription for at least one medication having a dosage automatically calculated based on the value of the measurement of at least one patient parameter, the dosage having a lower threshold limit and an upper threshold limit, the dosage being automatically calculated at identified intervals in response to periodic input from the patient and automatically transmitted to the patient via electronic device.

In another aspect, a computerized system programmed for providing care support to at least one patient having at least one chronic illness is provided. The computerized system comprises an application server having software configured to receive via input device and store in electronic format a prescription for a dosage of at least one medication, wherein the dosage varies based upon at least one patient parameter. The system being further configured to automatically electronically transmit a first message at an identified time to an electronic device associated with the patient, wherein the first message prompts the patient to input a measurement of the at least one patient parameter. The system also being configured to receive via electronic signal from the patient's electronic device, a second message comprising the measurement of the at least one patient parameter; and automatically calculate and electronically transmit to the patient's electronic device, a third message comprising the dosage of the at least one medication based on the measurement of the at least one patient parameter. The computerized system also comprises a storage unit, a transmission device for transmitting electronic messages, and a receiver configured to receive electronic messages.

In another aspect, a method for providing care support for a patient having at least one chronic illness is provided. The method comprises receiving via input device and storing in electronic format a prescription for a dosage of at least one medication, wherein the dosage varies based upon at least one patient parameter; automatically electronically transmitting a first message at an identified time to an electronic device associated with the patient, the first message prompting the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating one or more of the steps at identified intervals.

### BRIEF DESCRIPTION OF THE DRAWINGS

FIG. 1 is a flow diagram of the set up of the PSM system;

FIG. 2 is a flow diagram of set up and customization for a prescription algorithm; and

FIG. 3 is a diagram of the PSM system.

### DETAILED DESCRIPTION OF THE INVENTION

It should be understood that while various embodiments in the specification are presented using “comprising” language, under various circumstances, a related embodiment can also be described using “consisting of” or “consisting essentially of” language. It is to be noted that the term “a” or “an”, refers to one or more, for example, “a message,” is understood to represent one or more messages. As such, the terms “a” (or “an”), “one or more,” and “at least one” are used interchangeably herein.

The Patient Self-Management (PSM) System is a mobile healthcare delivery system featuring physician- or other physician representative-initiated care plans that are automated and customized for various patient conditions and disease states. The Patient Self-Management (PSM) System comprises a collection of server-based clinical algorithms, which enable patient interaction and promote patient health through text messages and share that content with electronic medical records. In one embodiment the term “PSM” refers to the selected algorithm, as more fully described below. In other embodiments, the term “PSM” refers to the entire PSM system, including the electronic interface whereby the physician accesses the system and enters or modifies a patient record and the automated system which performs its programmed functions, once enabled.

### System Overview

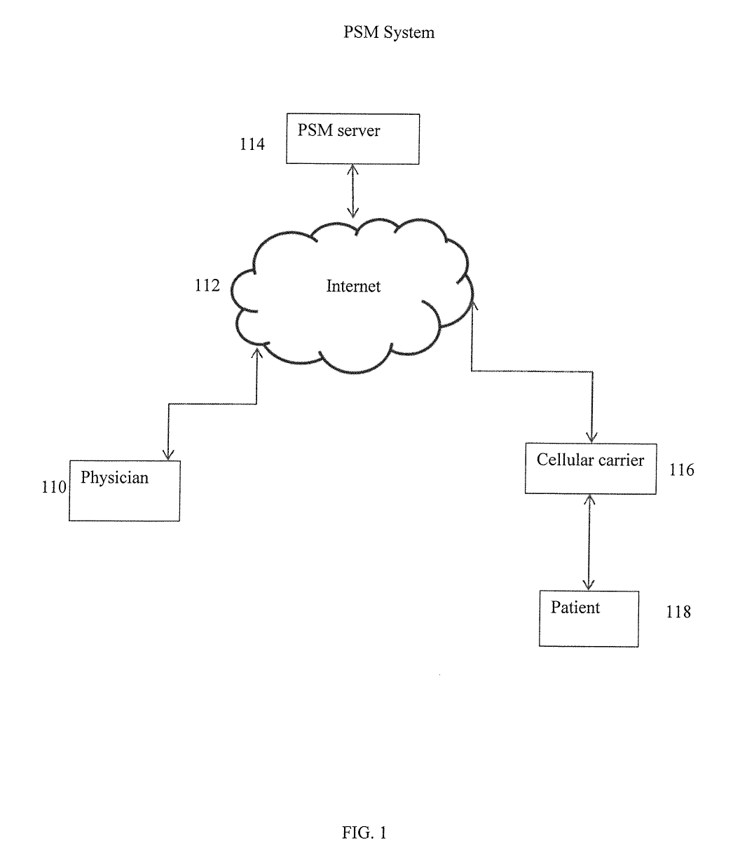

Referring to FIG. 1, the PSM system is housed on a PSM server 114. A physician or health care provider accesses the PSM system using a personal computer, smartphone or similar device 110 via the internet 112 in order to initialize, customize and/or modify a patient algorithm. Once customized and initialized, the PSM server sends messages to the patient via the internet 112 using his or her cellular carrier's communication system 116, which sends messages to the patient's mobile device 118. In some embodiments, the PSM system comprises additional components.

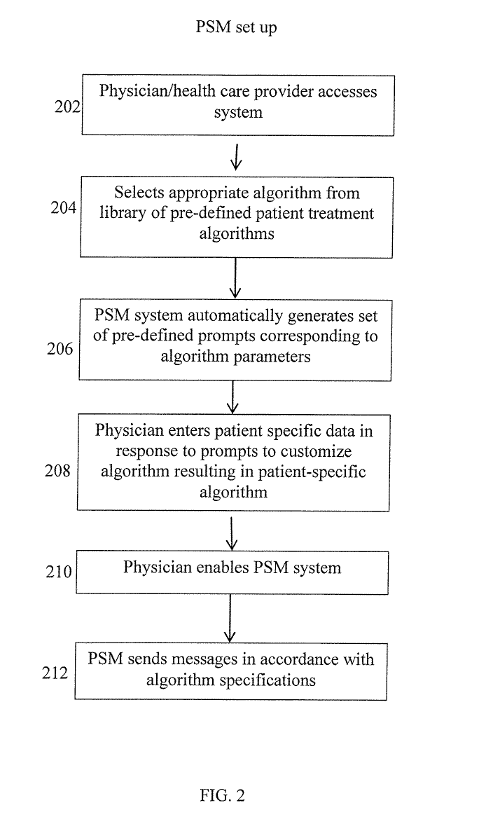

Referring to FIG. 2, the PSM system is accessed by the physician or health care provider 202 in order to initialize and configure the system for a patient for whom the physician believes the system will provide a benefit. The physician accesses the system which provides a library of pre-defined patient treatment algorithms to select from 204. Each algorithm is directed to a specific condition or set of circumstances for which an automated, patient-customized messaging system is indicated. The physician selects the algorithm which is appropriate for the condition or situation specific to the patient being treated 204. Based on the selected algorithm, the PSM system automatically generates a series of pre-defined prompts or questions which constitute the algorithm parameters 206. The physician enters responses to the prompts, also known hereinafter as patient-specific data, which customizes the treatment algorithm to the needs of the patient, resulting in a patient-specific algorithm 208. The physician then enables the PSM system 210, which then sends messages and otherwise executes the algorithm in accordance with the specifications 212.

### Algorithms

The PSM system functions using a set of pre-defined patient treatment algorithms which are stored in electronic format in the database server. Each “algorithm” is a pre-defined set of instructions for carrying out a program, treatment plan, recommendation, prescription, “sliding scale” prescription, or other pre-planned series of brief communications. Some of the algorithms are tailored for specific disease states, e.g., diabetes, congestive heart failure, asthma. Other algorithms are tailored for specific sets of tasks, e.g., to remind a patient to get a vaccine booster, remind the patient of an upcoming appointment, etc.

In one embodiment, the algorithm is designed to communicate a reminder or set of reminders to a patient. As a non-limiting list of examples, the reminders may be directed: to laboratory appointments, physician office appointments/follow-ups, completion of a health survey, request for a health form, etc.

In another embodiment, the algorithm is designed to ask a specific question or questions of the patient on a pre-determined schedule, and record the responses. As a non-limiting list of examples, the questions may be directed to: the patient's current health condition or the current state/measurement of a patient parameter (e.g., What was your blood pressure, weight, heart rate, etc.?); inquiring whether an appointment was scheduled; confirming that the patient will be able to attend a scheduled appointment.

In one embodiment, the term “patient parameter” refers to a biological, electrophysiological, or physical characteristic of the patient. In one embodiment, the patient parameter comprises one or more of the following: glucose level, weight, temperature, oxygen saturation, heart rate, cardiac rhythm read-out, pain level, and blood pressure. In one embodiment, the measurement is stored in electronic format.

In another embodiment, the algorithm is designed to execute a series of directions for treatment. As a non-limiting example, the algorithm may be tailored to prescribe a certain dosage of medication based on a specific health parameter, i.e, a “sliding scale” prescription. For example, the PSM system asks “what was your weight?”, receives that information, and conveys “take # tablets of your medicine”. In one embodiment, the PSM system tracks the number of pills remaining in a prescription and automatically sends a reminder to refill the prescription when a certain threshold level is reached.

The algorithm is selected based on the patient's health care status. By the term “patient's health care status” it is meant a physical, mental or environmental condition or situation associated with a patient for which health care treatment, advice, or input is desired. In some embodiments, the patient's health care status includes medical conditions, diseases, pregnancy, age, time of year (e.g., for seasonal allergies, flu shots, etc.), sexual history or activity, recent hospitalizations, recent treatments, or post-visit follow up. In one embodiment, the patient's health care status means a chronic health condition. In further embodiments, the chronic health condition is diabetes, congestive heart failure, asthma, or high blood pressure. In another embodiment, the patient's health care status means an acute illness or condition. In another embodiment, the patient's health care status relates to medical and/or laboratory appointments which have been made, need to be made, or have been recently held (e.g., for a follow-up survey or appointment). It is contemplated that other patient conditions and situations other than those specifically identified here are encompassed by the invention.

In one embodiment, by “physician” or “health care provider” it is meant the patient's primary health care physician, emergency room physician, specialist, physician, physician assistant, nurse, nurse practitioner, pharmacist, or CNA. The terms “physician” and “health care provider” are used interchangeably herein. In one embodiment, the term “physician” refers to the person entering the prescription or algorithm into the PSM system.

After selecting the algorithm, the health care provider customizes the algorithm using the algorithm parameters. The “algorithm parameters” are a set of specific pre-defined prompts or questions, which are tailored to the specific algorithm and the disease state, patient condition, desired recommendations, etc., that the algorithm corresponds to. The algorithm parameters prompt the physician for all of the information necessary in order to carry out the algorithm for the specific patient. The physician inputs “patient specific data” in response to the prompts which are automatically generated by the PSM system based upon the selected algorithm. Thus, the term “patient specific data” includes any information provided to the system by the health care provider in order to tailor the algorithm for the specific patient. In one embodiment, patient specific data includes patient medical or biographical information, including information from the patient's medical record. In another embodiment, patient specific data includes information relating to a medication prescription, including the name, dosage, length of time for the prescription, etc. In another embodiment, patient-specific data includes information relating to execution of the PSM system, including the frequency of messages, time of day messages are to be sent, alert trigger thresholds, or information relating to prescriptions including refill reminders, pick-up times, and pharmacy specific information.

The algorithm parameters allow for complete customization of each algorithm for the individual patient. However, in another embodiment, the algorithm is customized by amending the algorithm itself In one embodiment, the algorithm is customized by the addition of one or more new algorithm parameters. In another embodiment, the algorithm is customized by the deletion of one or more pre-defined algorithm parameters. In yet another embodiment, the algorithm is customized by the amendment of one or more pre-defined algorithm parameters. In another embodiment, the physician enters a new algorithm.

### Prescriptions

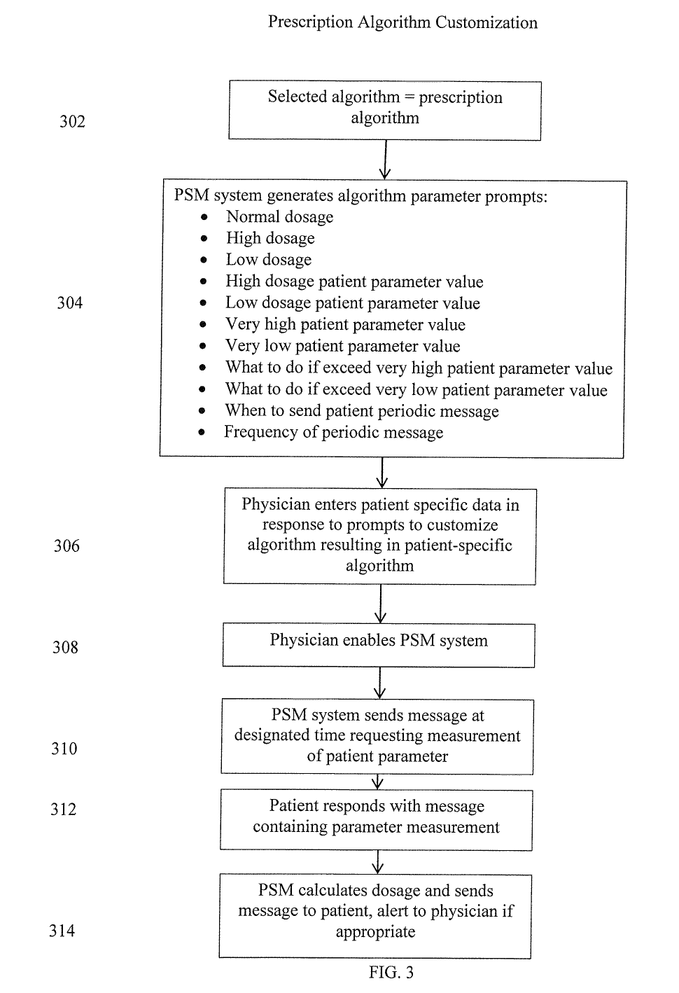

In one embodiment, the selected algorithm (204 of FIG. 2) is directed to a prescription. Referring to FIG. 3, the PSM system then generates the algorithm parameter prompts corresponding to the selected prescription algorithm 302. These algorithm parameters are specifically tailored for each prescription but may include 304:
Normal dosage
High dosage
Low dosage
High dosage patient parameter value
Low dosage patient parameter value
Very high patient parameter value
Very low patient parameter value
What to do if exceed very high patient parameter value
What to do if exceed very low patient parameter value
When to send patient periodic message
Frequency of periodic message

The physician then enters patient specific data in response to the prompts in order to customize the algorithm for the patient 306. For example, the “normal dosage” of the medication may be specified based on the normal weight of the patient; one patient may be given a greater or lesser tolerance in what constitutes a “high” patient parameter, etc. After entering the patient-specific data, the physician enables the PSM system 308, which begins to send messages at the designated time 310. The PSM system prompts the patient to enter a measurement of a patient specific parameter 310. The patient sends a message containing the measurement 310. The PSM system calculates the correct dosage of medication based on the measured parameter and sends the dosage to the patient via message 314. The PSM system also sends an alert to the caregiver if appropriate 314.

In one embodiment, the term “prescription” refers to a health-care program implemented by a physician or health care provider in the form of instructions that govern the plan of care for an individual patient. In a preferred embodiment, the term “prescription” refers to a physician's order to take a certain medication.

Prescription medications can only be prescribed by a physician or someone else authorized by law. The physician retains liability for writing the prescription thru the PSM system through the use of use of a unique identifier code or digital signature in order to enter or modify a prescription. Thus, the physician assumes liability in that he or she is giving the patient instructions in self-titration of medications. All prescription algorithms contain limits whereby only specified range of dosages will be transmitted to the patient.

For most medications, the amount of medication that the patient must take varies based upon one or more patient parameters. In the case of some acute illnesses, the patient parameters are generally static enough over the course of treatment such that the physician can prescribe a specific dose of the medication for the duration of the treatment (or specify a variable dosage at the beginning of treatment). However, for certain chronic illnesses, the dosage of one or more medications can vary based on one or more patient parameters, which can change on a daily, weekly, or monthly basis. For these illnesses, it is not practical that the physician consult with the patient each day or each time the medication is to be taken.

Instead, the present invention provides a method whereby a physician can provide a “sliding scale” prescription to a patient, wherein the dosage of the medication is varied based upon the measurement of at least one patient parameter. By using the automated system, the patient need not remember the “sliding scale” calculations. Further, because the patient receives periodic (daily, weekly, etc.) prompts from the system to measure/input the patient parameter, the patient is more likely to take the measurement and modify the medication dosage as directed by the system.

In one embodiment, the term “patient parameter” means refers to a biological, electrophysiological, or physical characteristic of the patient. In one embodiment, the patient parameter comprises one or more of the following: glucose level, weight, temperature, oxygen saturation, heart rate, cardiac rhythm read-out, pain level, and blood pressure. In one embodiment, the measurement is stored in electronic format.

In one embodiment, the algorithm is configured such that an alert is automatically transmitted to an electronic device of a health care provider when the measurement of the at least one patient parameter exceeds an upper threshold limit. In another embodiment, an alert is automatically transmitted to an electronic device of a health care provider when the measurement of the at least one patient parameter falls below a lower threshold limit. In one embodiment, the alert is sent via email, pager or text message. By sending an alert to the caregiver upon receipt of the problematic patient parameter measurement, the caregiver is put on early notice of a situation which may require additional intervention. By identifying the problem early, it is possible to reduce the intensity of intervention required and prevent hospital admissions. In one embodiment, the term “health care provider” refers to the person receiving an automatic alert from the PSM system. In this embodiment, the health care provider may be one of the providers mentioned above or another person who gives care to the patient, e.g., a family member.

In one embodiment of the invention, the prescription is editable by a health care provider. As discussed above, each algorithm, including those which provide prescriptions for medication, is fully customizable at the time of entry. However, each algorithm may also be edited at any time. Thus, a prescription may be edited by the physician even after the PSM system has been initiated. For example, if the patient parameter measurements have been tending in one direction, the physician may increase or decrease the dosage of medication in order to compensate for the fluctuating readings.

In one embodiment, the measurements input by the patient are stored in electronic format. In one embodiment, the measurements are stored in the patient's electronic medical record. By storing the data electronically, the physician has real time access to the information, the information is legible, stored securely (protected against patient privacy breaches), stored longitudinally, and easily modifiable, where appropriate. In another embodiment, the messages sent by the PSM system are stored in electronic format.

The PSM system may be accessed by the physician on their personal computer, smartphone or similar device. In a preferred embodiment, the algorithm is configured using a computer.

In one embodiment, the term input device refers to any hardware that sends data to the computer or other electronic device. In one embodiment, the input device may be a keyboard, a mouse, a barcode reader, a stylus, a microphone, or a touch sensitive screen. In a preferred embodiment, the input device is a keyboard.

In one embodiment, the term “message” refers a to a text message. In one embodiment, a “text message” is a brief written text message, usually around 160 characters or fewer, that is sent from and/or received by a mobile device using SMS MMS protocol. As used herein, the terms “SMS message” and “text message” are used interchangeably. “Short Message Service” (“SMS”) is a communication protocol that facilitates the exchange of text messages between mobile devices. An “MMS message” is a Multimedia Messaging Service message that may include multimedia objects such as images, audio, video and/or the like. In another embodiment, the term “message” refers to an electronic mail (“email”) communication. In yet another embodiment, the term “message” refers to a voice mail message. In a preferred embodiment, the message is a text message.

In one embodiment, the text message may be sent using a short code. A “short code” is a special telephone number that is significantly shorter than typical telephone numbers. A short code may be used to address SMS and MMS messages from mobile devices.

In one embodiment, the term “electronic device associated with the patient” refers to a computer, personal data assistant, pager or mobile device. The term “mobile device” refers to a portable electronic device such as a mobile or cellular phone, a PDA, a media player or the like. A mobile device may have a processor and a processor-readable storage medium in communication with the processor, and may communicate with a health manager via a wireless network, a cellular telephone network and/or the like. A mobile device may have one or more of a display screen, a keypad, a stylus and a touch screen. Although in some embodiments, the mobile device may be a device which combines the capabilities of a phone with that of a personal data assistant, GPS, web access, etc., i.e., a smartphone, the invention contemplates the use of basic cellular phones having text messaging capabilities. Because no per-patient investment is required beyond a basic cellular phone with text messaging, which most people already possess and use regularly, the invention targets the underserved, by not requiring an expensive PDA phone (smartphone), carrier data plan, or any computer competency. Extending the benefits of telemedicine to this large demographic represents a major shift away from the prevailing direction in the industry which is currently focused on developing new technologies and equipment, which drives cost and still suffers from limited access.

In a preferred embodiment, the electronic device associated with the patient is a mobile phone and the messages are SMS messages. In another embodiment, an electronic message is sent to the patient's mobile phone to validate connectivity and accuracy of the phone number.

### Methods

In one aspect, the invention provides a method for managing patient care. The method comprises receiving from a health care provider, via input device and storing in electronic format, a selection of a specific patient treatment algorithm from a list of pre-defined treatment algorithms, the selection corresponding to a patient's health care status; automatically generating a series of prompts based on the selected algorithm, the prompts requesting patient-specific data; receiving from the health care provider, via input device and storing in electronic format, the patient-specific data in response to prompts. The data provide a patient-customized algorithm. The method further comprises automatically generating and transmitting an electronic message to an electronic device associated with the patient, the electronic message being generated based on the patient customized algorithm.

In one embodiment, the electronic message prompts the patient for information associated with the patient's health care status. In another embodiment, the method further comprises receiving via electronic signal from the patient's electronic device, a second message comprising information associated with the patient's health care status. In another embodiment, one or more of the steps are repeated. In another embodiment, the algorithms are customized by the health care provider.

In one embodiment, the invention provides a method for managing patient care, the method comprising receiving via input device and storing in electronic format a prescription for a dosage of at least one medication, wherein the dosage varies based upon at least one patient parameter; automatically electronically transmitting a first message at an identified time to an electronic device associated with the patient, the first message prompting the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating one or more of the steps at identified intervals. In one embodiment, the algorithm is configured such that an alert is automatically transmitted to an electronic device of a health care provider when the measurement of the at least one patient parameter exceeds an upper threshold limit. In another embodiment, an alert is automatically transmitted to an electronic device of a health care provider when the measurement of the at least one patient parameter falls below a lower threshold limit. In one embodiment, the alert is sent via email, pager or text message. In one embodiment, the at least one patient parameter comprises one or more of the following: glucose level, weight, temperature, oxygen saturation, heart rate, cardiac rhythm read-out, pain level, and blood pressure. In one embodiment, the electronic device associated with the patient is a computer, personal data assistant, pager or mobile phone. In a preferred embodiment, the electronic device associated with the patient is a mobile phone and the messages are SMS messages. In yet another embodiment, an electronic message is sent to the patient's mobile phone to validate connectivity and accuracy of phone number.

In another aspect, the invention provides a method for managing patient care comprising developing and electronically recording and storing a plan of treatment for a patient. The plan of treatment comprises a prescription for at least one medication. The dosage is automatically calculated based on the value of the measurement of at least one patient parameter; has a lower threshold limit and an upper threshold limit; and is automatically calculated at identified intervals in response to periodic input from the patient and automatically transmitted to the patient via electronic device.

In another aspect, a method for providing care support for a patient having at least one chronic illness is provided. The method comprises receiving via input device and storing in electronic format a prescription for a dosage of at least one medication, wherein the dosage varies based upon at least one patient parameter; automatically electronically transmitting a first message at an identified time to an electronic device associated with the patient, the first message prompting the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating any of the steps at identified intervals. In one embodiment, the one chronic illness is congestive heart failure, diabetes, high blood pressure or asthma. In another embodiment, the method further comprises automatically transmitting an alert to an electronic device of a health care provider when the measurement of the at least one patient parameter exceeds an upper threshold limit. In another embodiment, the method further comprises automatically transmitting an alert to an electronic device of a health care provider when the measurement of the at least one patient parameter falls below a lower threshold limit. In yet another embodiment, the prescription is editable by a health care provider.

In another embodiment, the measurement of the at least one patient parameter is stored in electronic format. Because the system electronically records all information transmitted by the patient, the physician will be aware of the level of participation of the patient at any given point. Further, integration with electronic medical records is easily accomplished.

In one embodiment, the at least one patient parameter comprises one or more of the following: glucose level, weight, temperature, oxygen saturation, heart rate, cardiac rhythm read-out, pain level, and blood pressure. In one embodiment, the electronic device associated with the patient is a computer, personal data assistant, pager or mobile phone. In a preferred embodiment, the electronic device associated with the patient is a mobile phone and the messages are SMS messages. In yet another embodiment, an electronic message is sent to the patient's mobile phone to validate connectivity and accuracy of phone number.

### System

In another aspect, a computerized system programmed for providing care support to at least one patient having at least one chronic illness is provided. The computerized system comprises an application server having software configured to receive via input device and store in electronic format a prescription for a dosage of at least one medication, wherein the dosage varies based upon at least one patient parameter. The software is further configured to automatically electronically transmit a first message at an identified time to an electronic device associated with the patient, wherein the first message prompts the patient to input a measurement of the at least one patient parameter; receive via electronic signal from the patient's electronic device, a second message comprising the measurement of the at least one patient parameter; and automatically calculate and electronically transmit to the patient's electronic device, a third message comprising the dosage of the at least one medication based on the measurement of the at least one patient parameter. The computerized system also comprises a storage unit; a transmission device for transmitting electronic messages; and a receiver configured to receive electronic messages. In one embodiment, the at least one chronic illness is congestive heart failure, diabetes, high blood pressure or asthma.

In another embodiment, a computerized system programmed for providing care support to at least one patient. The computerized system comprises an application server having software configured to receive from a health care provider, via input device and storing in electronic format, a selection of a specific patient treatment algorithm from a list of pre-defined treatment algorithms, the selection corresponding to a patient's health care status. The software is further configured to automatically generate a series of prompts based on the selected algorithm, the prompts requesting patient-specific data; receive from the health care provider, via input device and storing in electronic format, the patient-specific data in response to prompts, the data providing a patient-customized algorithm; and automatically generate and transmit an electronic message to an electronic device associated with the patient, the electronic message being generated based on the patient customized algorithm. In one embodiment, the computerized system comprises an application server having software further configured to prompt the patient for information associated with the patient's health care status, receive via electronic signal from the patient's electronic device, a second message comprising information associated with the patient's health care status.

### Computer-Usable Medium

In one aspect, the invention provides a computer-usable medium comprising a computer program code. The computer program code is configured to cause a processor to execute one or more functions. In one embodiment, the functions comprise receiving via input device and storing in electronic format a prescription for a dosage of at least one medication, wherein the dosage varies based upon at least one patient parameter; automatically electronically transmitting a first message at an identified time to an electronic device associated with the patient, wherein the first message prompts the patient to input a measurement of the at least one patient parameter; receiving via electronic signal from the patient's electronic device, a second message comprising the measurement of the at least one patient parameter; automatically calculating and electronically transmitting to the patient's electronic device, a third message comprising the dosage of the at least one medication based on the measurement of the at least one patient parameter; and repeating one or more of the steps at identified intervals.

In another embodiment, a computer program code is configured to cause a processor to execute one or more functions. The functions comprise receiving from a health care provider, via input device and storing in electronic format, a selection of a specific patient treatment algorithm from a list of pre-defined treatment algorithms, the selection corresponding to a patient's health care status. The functions further comprise automatically generating a series of prompts based on the selected algorithm, the prompts requesting patient-specific data; receiving from the health care provider, via input device and storing in electronic format, patient-specific data in response to prompts, the data providing a patient-customized algorithm; and automatically generating and transmitting an electronic message to an electronic device associated with the patient, the electronic message being generated based on the patient customized algorithm. In another embodiment, the electronic message prompts the patient for information associated with the patient's health care status. In a further embodiment, the functions further comprise receiving via electronic signal from the patient's electronic device, a second message comprising information associated with the patient's health care status.

In one embodiment, the term “computer readable media/medium” include CD ROM, a floppy disk, a flash drive, a hard drive, read only memory (ROM), random access memory (RAM), any other computer-usable medium, as well as other physical media capable of storing software and/or combinations thereof.

### Specific Embodiments

Congestive heart failure (CHF) is a diagnosis that mostly affects patients over 60 years-old. The condition has a number of causes, including longstanding high blood pressure, exposure to various toxins and congenital defects all leading to a vastly weakened heart. Rather than function as a forceful muscle, the walls of the heart are “baggy” and unable to generate much force. Ejection Fraction, or EF, refers to the fraction of blood that leaves the heart compared to the amount that enters. Normal adults pump out about 65% of all the blood that enters. However, patients with CHF tend to have EFs less than 40 or even 20 percent. With a low EF, the blood “backs up” into the patient's lungs. The extra blood puts pressure on the walls of the vessels, which, in turn, leak fluid into the air ways. When fluid is in the airways, the patient can't exchange oxygen and the patient feels short of breath.

A number of events can cause a person to suddenly have a weaker heart. Drinking too much alcohol, for example, (called “holiday heart”) can cause acute weakness of the walls through toxic effects on the muscle. On the other hand, eating a lot of salty canned soup causes the body to pull water into the blood vessels and as a result, deliver much more volume to the heart. Any number of these changes can weaken the heart in a matter of days so early detection is important.

One of the medications in the “cocktail” given to a CHF patient each day is furosemide, a diuretic. By increasing urination, the kidney lets go of extra water so the blood is carrying less of it. If the blood has less water, then the heart has less weight to pump. How much furosemide a patient takes is a function of how much “extra” water the patient is carrying. For these patients, the amount of extra water is measured by total body weight. All patients have a “dry weight,” which is their weight when the blood has just enough but not too much water and the heart is in optimal conditions.

Thus, the goal in patient-self management in a CHF patient is to have the patient weigh themselves daily and adjust the furosemide dosage accordingly, to avoid excessive weight gain and prevent hospital re-admission. The present invention provides an electronic toolkit which improves adherence to the self-management regime. After making a determination that the patient is an appropriate candidate for the PSM system, the physician (or qualified assistant) accesses the PSM system using a unique identifier. The physician enters basic patient information including name, cell phone number, and electronic medical records (EMR) record number. In the presence of patient, physician (or qualified assistant) sends a text message to patient's phone to validate connectivity and accuracy of the phone number. Patient replies to the text message and the system validates bi-directional connectivity.

The physician or assistant accesses the system, which provides a library of algorithms. In the case of a prescription for medication, after selecting the algorithm from the library of algorithms, the physician selects the date range over which this prescription is to be active; selects the time of day to send the first message to the patient; enters the medication parameters (dosage size and count); and fills out the parameters specific to the selected algorithm. The algorithm is selected for a patient having congestive heart failure (CHF). The algorithm parameters include:
i. Patient's dry weight
ii. Incremental weight that constitutes “low weight”
iii. Incremental weight that constitutes “high weight”
iv. Incremental weight that constitutes “very low weight”
v. Incremental weight that constitutes “very high weight”
vi. Message if current weight is regular (take X tablets Y times per day)
vii. Message if current weight is low (take W tablets Y times per day)
viii. Message if current weight is high (take Z tablets Y times per day)
ix. Message if current weight is very low (call your physician at 123-555-9999)
x. Message if current weight is very high (call your physician at 123-555-9999)

Once the algorithm parameters have been entered, the PSM system is now fully enabled for use by the patient. The physician releases the patient and the patient begins self-management.

The algorithm parameters described above can be amended, added to or taken away from as the health care provider deems necessary in order to tailor the algorithm to the patient's needs.

Upon release from the physician, the PSM algorithm is executed at the pre-programmed start time. The PSM is initiated by sending a prompt message to the patient at the configured time of day. For a patient having congestive heart failure (CHF), the prompt instructs the patient to reply with their weight in lbs. The patient receives the prompt message on his/her phone. The patient takes his/her own weight, creates a reply text message, enters the weight value and sends the message. The PSM receives the text message and looks up the current prescription for the patient based on the incoming phone number. The PSM runs the prescription and determines the response message based on the received weight and the configured algorithm parameters in the prescription. The PSM creates EMR transaction entry for real-time or batch EMR data reports, or it can store the data in a separate PSM-specific website. The PSM then sends the response message, which contains the correct dosage of furosemide for the patient's current weight. The patient receives response message on his/her phone and follows the instructions.

The physician (or qualified assistant) enters the basic patient information including name, cell phone number, and EMR record number. In the presence of patient, physician (or qualified assistant) sends a text message to patient's phone to validate connectivity and accuracy of phone number. Patient replies to the text message and the system validates bi-directional connectivity.

While the above-described prescription embodiment is related to congestive heart failure, as described herein the invention algorithms are useful in maintaining many chronic conditions. In one embodiment, the patient condition is diabetes, the medication is insulin and the patient parameter is blood sugar. In another embodiment, the patient condition is congestive heart failure, the medication is furosemide and the patient parameter is weight. In another embodiment, the patient condition is high blood pressure, the medication is hydrochlorothiazide, and the patient parameter is blood pressure. In another embodiment, the patient condition is asthma, the medication is albuterol, and the patient parameter is cough or shortness of breath. In another embodiment, the patient condition is pruitis (itching) and the medication is prescribed topical treatment. In such embodiment, the “dosage” relates to frequency of applications of the topical treatment.

Many vaccines are given to patients in a series of doses. However, getting patients to complete the dosage series is often difficult. The present invention provides a patient-customized reminder system in order to increase dosing compliance. The physician prescribes the patient's reminder plan with the following steps. Physician selects the appropriate algorithm from the library of algorithms (e.g., HPV Gardasil). The physician customizes the algorithm using patient-specific data including:
i. Select the date range over which this prescription is to be active
ii. Select the time of day to send the prompt text message to the Patient
iii. Fill out the HPV algorithm parameters:
   A. Date of 2 month reminder
   B. Date of 6 month reminder

The physician releases the patient and the patient begins self-management.

The PSM algorithm is executed at the pre-programmed start time. The PSM initiates by sending prompt message to the patient at the configured time of day. The prompt reminds patient to make appointment for vaccination, and asks for a Yes or No response if they have made appointment. The patient creates a reply text message, enters Yes or No and sends the message. PSM receives the text message. PSM looks up the current prescription for the Patient based on the incoming phone number. PSM runs the prescription and determines the action: if “Yes” was received, the reminder is marked as completed; if “No” was received, the reminder is left active so that another reminder will be sent tomorrow. PSM creates EMR transaction entry for real-time or batch EMR data export.

The methods and systems of the invention can be utilized with a variety of patient conditions, diseases and illnesses. In a specific embodiment, the methods and systems are utilized for patients having a condition in which a measureable parameter affects changes in the treatment of the condition.

While preferred methods, systems and software programs have been described in detail, various modifications, alterations, and changes may be made without departing from the spirit and scope of the present invention as defined in the appended claims.

Each of the publications referenced herein as well as priority application No. 61/547,304 are hereby incorporated by reference herein its entirety.

What is claimed is:

1. A method for managing patient care, the method comprising:
(a) receiving via input device and storing in electronic format a prescription for a dosage of at least one medication, wherein the dosage varies based upon at least one patient parameter;
(b) automatically electronically transmitting a first message at an identified time to an electronic device associated with the patient, the first message prompting the patient to input a measurement of the at least one patient parameter;
(c) receiving via electronic signal from the patient's electronic device, a second message comprising the measurement of the at least one patient parameter;
(d) automatically calculating and electronically transmitting to the patient's electronic device, a third message comprising the dosage of the at least one medication based on the measurement of the at least one patient parameter; and
(e) repeating steps (b)-(d) at identified intervals.

2. The method of claim 1, wherein the patient has at least one chronic illness.

3. The method of claim 2, wherein the at least one chronic illness is congestive heart failure, diabetes, high blood pressure or asthma.

4. The method of claim 1, comprising automatically transmitting an alert to an electronic device of a health care provider when the measurement of the at least one patient parameter exceeds an upper threshold limit or falls below a lower threshold limit.

5. The method of claim 1, wherein the prescription is editable by a health care provider.

6. The method of claim 5, wherein the health care provider is a physician.

7. The method of claim 1, wherein the measurement received in step (c) is stored in electronic format.

8. The method of claim 1, wherein the at least one patient parameter comprises one or more of the following: glucose level, weight, temperature, oxygen saturation, heart rate, cardiac rhythm read-out, pain level, and blood pressure.

9. The method of claim 1, wherein the electronic device associated with the patient is a computer, personal data assistant, pager or mobile phone.

10. The method of claim 9, wherein the electronic device associated with the patient is a mobile phone and the messages are SMS messages.

11. The method of claim 10, further comprising the step of electronically sending a message to the patient's mobile phone to validate connectivity and accuracy of phone number.

12. A computer-usable medium comprising a computer program code configured to cause a processor to execute one or more functions comprising:
(a) receiving via input device and storing in electronic format a prescription for a dosage of at least one medication, wherein the dosage varies based upon at least one patient parameter;
(b) automatically electronically transmitting a first message at an identified time to an electronic device associated with the patient, wherein the first message prompts the patient to input a measurement of the at least one patient parameter;
(c) receiving via electronic signal from the patient's electronic device, a second message comprising the measurement of the at least one patient parameter;
(d) automatically calculating and electronically transmitting to the patient's electronic device, a third message comprising the dosage of the at least one medication based on the measurement of the at least one patient parameter; and
(e) repeating steps (b)-(d) at identified intervals.

13. The computer-usable medium of claim 12, wherein the prescription of step (a) is editable by a health care provider.

14. The computer-usable medium of claim 13, wherein the health care provider is a physician.

15. A method for managing patient care, the method comprising:
(a) receiving from a health care provider, via input device and storing in electronic format, a selection of a specific patient treatment algorithm from a list of pre-defined treatment algorithms, said selection corresponding to a patient's health care status;
(b) automatically generating a series of prompts based on the selected algorithm, said prompts requesting patient-specific data;
(c) receiving from said health care provider, via input device and storing in electronic format, said patient-specific data in response to prompts, said data providing a patient-customized algorithm;
(d) automatically generating and transmitting an electronic message to an electronic device associated with the patient, said electronic message being generated based on said patient customized algorithm.

16. The method of claim 15, wherein the electronic message of step (c) prompts the patient for information associated with the patient's health care status, and further comprising the step of
(e) receiving via electronic signal from the patient's electronic device, a second message comprising said information associated with the patient's health care status.

17. The method of claim 15, further comprising repeating steps (c) and (d).

18. The method of claim 15, wherein said treatment algorithms are customizable.

19. The method of claim 15, wherein the health care provider is a physician and the algorithm is directed to a prescription for medication.

20. The method of claim 15, wherein the algorithm is directed to communicating at least one reminder to the patient.
